(19) United States
(12) Patent Application Publication
(10) Pub. No.: US 2021/0208609 A1
(43) Pub. Date: Jul. 8, 2021

(54) UNMANNED AERIAL VEHICLE CONTROL METHOD, AND UNMANNED AERIAL VEHICLE

(71) Applicant: SZ DJI TECHNOLOGY CO., LTD., Shenzhen (CN)

(72) Inventors: Yang LI, Shenzhen (CN); Chen CHEN, Shenzhen (CN)

(21) Appl. No.: 17/206,105

(22) Filed: Mar. 18, 2021

Related U.S. Application Data
(63) Continuation of application No. PCT/CN2018/108774, filed on Sep. 29, 2018.

(51) Int. Cl. G05D 1/10; B64C 39/02; B64D 43/02; G08G 5/04; G01P 5/165

(52) U.S. Cl. CPC G05D 1/1062; B64C 39/024; B64D 43/02; G01S 19/49; G01P 5/165; B64C 2201/027; B64C 2201/14; G08G 5/045

(57) ABSTRACT

A method for controlling an unmanned aerial vehicle includes generating a course reversal command to control the unmanned aerial vehicle to execute a course reversal action. The course reversal action includes at least a cruising stage. The method further includes, in the cruising stage, measuring one or more flight parameters of the unmanned aerial vehicle and controlling the unmanned aerial vehicle to enter a high wind course reversal stage in response to determining that the unmanned aerial vehicle is in a high wind retardant state according to the one or more flight parameters. The method also includes, in the high wind course reversal stage, measuring the one or more flight parameters, and controlling the unmanned aerial vehicle to return to the cruising stage in response to determining that the unmanned aerial vehicle is not in the high wind retardant state according to the one or more flight parameters.

### CROSS-REFERENCE TO RELATED APPLICATION

This application is a continuation of International Application No. PCT/CN2018/108774, filed Sep. 29, 2018, the entire content of which is incorporated herein by reference.

### TECHNICAL FIELD

The present disclosure relates to the field of unmanned aerial vehicle and, more particularly, to an unmanned aerial vehicle control method and an unmanned aerial vehicle.

### BACKGROUND

An unmanned aerial vehicle may encounter high wind during the flight process such as course reversal or a normal operation. When the wind is very strong, the forward flight component of propulsion of the unmanned aerial vehicle may not be enough to offset the wind, which will reduce the speed of the unmanned aerial vehicle or even stop the unmanned aerial vehicle. Wind may also cause the heading of the unmanned aerial vehicle to deviate largely from a preset heading. However, existing technologies do not detect strong winds, and the unmanned aerial vehicle will not avoid high wind during the flight, which will easily cause the unmanned aerial vehicle to run out of power and fail to reach a target point. The flight safety of the unmanned aerial vehicle may be affected.

### SUMMARY

In accordance with the disclosure, there is provided a method for controlling an unmanned aerial vehicle including generating a course reversal command to control the unmanned aerial vehicle to execute a course reversal action. The course reversal action includes at least a cruising stage. The method further includes, in the cruising stage, measuring one or more flight parameters of the unmanned aerial vehicle and controlling the unmanned aerial vehicle to enter a high wind course reversal stage in response to determining that the unmanned aerial vehicle is in a high wind retardant state according to the one or more flight parameters. The method also includes, in the high wind course reversal stage, measuring the one or more flight parameters, and controlling the unmanned aerial vehicle to return to the cruising stage in response to determining that the unmanned aerial vehicle is not in the high wind retardant state according to the one or more flight parameters.

Also in accordance with the disclosure, there is provided an unmanned aerial vehicle including a vehicle body, at least one measurement device arranged at the vehicle body and configured to measure one or more flight parameters of the unmanned aerial vehicle, and a controller arranged at the vehicle body and configured to generate a course reversal command to control the unmanned aerial vehicle to execute a course reversal action. The course reversal action includes at least a cruising stage. The controller is further configured to, in the cruising stage, control the unmanned aerial vehicle to enter a high wind course reversal stage in response to determining that the unmanned aerial vehicle is in a high wind retardant state according to the one or more flight parameters and, in the high wind course reversal stage, control the unmanned aerial vehicle to return to the cruising stage in response to determining that the unmanned aerial vehicle is not in the high wind retardant state according to the one or more flight parameters.

### BRIEF DESCRIPTION OF THE DRAWINGS

FIG. 1 is a flow chart of an exemplary control method of an unmanned aerial vehicle consistent with various embodiments of the present disclosure.

FIG. 2 is a flow chart showing an exemplary course reversal action of an unmanned aerial vehicle consistent with various embodiments of the present disclosure.

FIG. 3 is a structural diagram of an exemplary Pitot tube of an unmanned aerial vehicle consistent with various embodiments of the present disclosure.

FIG. 4 is a structural diagram of an exemplary unmanned aerial vehicle consistent with various embodiments of the present disclosure.

FIG. 5 is a top view of an exemplary unmanned aerial vehicle consistent with various embodiments of the present disclosure.

FIG. 6 is a top view of another exemplary unmanned aerial vehicle consistent with various embodiments of the present disclosure.

FIG. 7 is a top view of another exemplary unmanned aerial vehicle consistent with various embodiments of the present disclosure.

### REFERENCE NUMERALS

1a, 1b, 1c—Unmanned aerial vehicle
10a, 10b, 10c—Vehicle body
11a, 11b, 11c—Controller
12a, 12b, 12c—Positioning device
13a, 13c—Airspeed meter
131a, 131c—Pitot tube
1311—Total pressure hole, 1312—Static pressure hole, 1313—Total pressure outlet tube, 1314—Static pressure outlet tube, 1315—Alignment handle,
D—Probe diameter, d—Total pressure hole diameter
131a, 132c—Pressure gauge
133a, 133c—Support tube
14a, 14b, 14c—Obstacle detector
20a, 20b, 20c—Propulsion device
θ—Angle, p1, p2—Pitot tube position, α—Maximum flight inclination angle
R—Area affected by airflow
W—Wind direction
W1—Component of wind direction parallel to crusing heading
W2—Component of wind direction perpendicular to crusing heading
C—Crusing heading, E—Actual heading

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” “front,” “back,” “lower,” “upper,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. Further, “plurality of” means at least two.

The present disclosure provides a control method of an unmanned aerial vehicle. As illustrated in FIG. 1, the method includes S101-S103.

At S101, a course reversal command is sent to the unmanned aerial vehicle such that the unmanned aerial vehicle executes a course reversal action. The course reversal action at least includes a cruising stage.

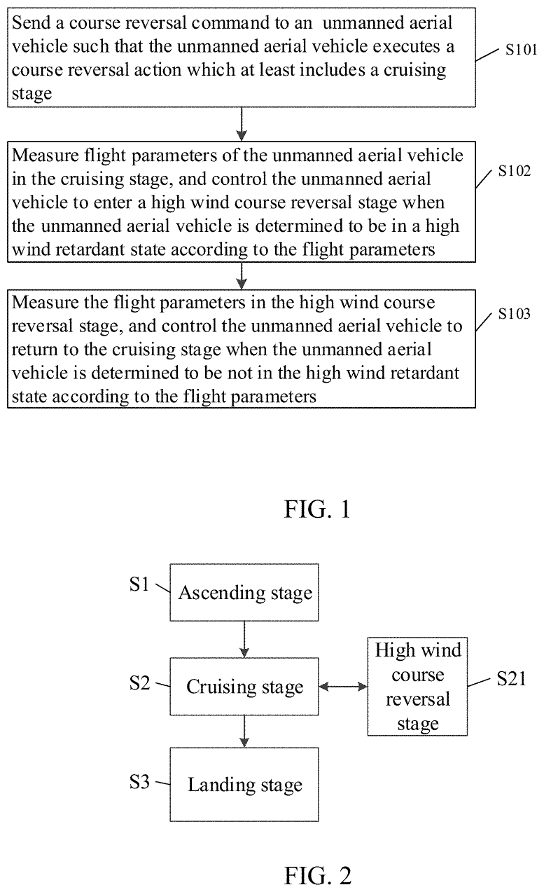

As illustrated in FIG. 2, the course reversal action includes a climbing stage S1, a cruising stage S2, and a landing stage S3. The cruising stage S2 includes a high wind course reversal stage S21.

The climbing stage includes stages such as preparation for course reversal, forced ascending, heading alignment, automatic ascending, etc.

The unmanned aerial vehicle may first perform a braking and hovering operation to prepare for course reversal. When the unmanned aerial vehicle is in a hovering state, or its speed is lower than a preset speed, or the time for performing the braking and hovering operation has exceeded a preset time, the unmanned aerial vehicle may enter the forced ascending stage.

During the forced ascending stage, the unmanned aerial vehicle may ascend at a preset speed. When the unmanned aerial vehicle reaches a preset altitude or the time for forced ascending has exceeded a preset time, the unmanned aerial vehicle may enter the heading alignment stage.

In the heading alignment stage, the unmanned aerial vehicle may hover at the preset height and adjust the heading to align with the cruise heading. A head of the unmanned aerial vehicle may point toward the home point or a tail of the unmanned aerial vehicle may point toward the home point. When the difference between the actual heading of the unmanned aerial vehicle and the cruise heading is less than a preset angle, or the time for heading adjustment has exceeded a preset time, the unmanned aerial vehicle may enter the automatic ascending stage.

During the automatic ascending stage, the unmanned aerial vehicle may rise to the cruise altitude at a preset speed. The cruise altitude may be a smaller one between a preset course reversal altitude and the unmanned aerial vehicle altitude limit. When the unmanned aerial vehicle rises to the cruise altitude, or the time for automatic ascending has exceeded a preset time, or the unmanned aerial vehicle receives a throttle stick operation command, the unmanned aerial vehicle may enter the cruising stage.

During the cruising stage, the unmanned aerial vehicle may fly towards the home point at a preset speed. When the unmanned aerial vehicle reaches directly above the home point, the cruising stage may end and the unmanned aerial vehicle may enter the landing stage.

During the landing stage, the unmanned aerial vehicle may descend at a preset speed until it reaches a target point and the course reversal action is completed.

Further, the unmanned aerial vehicle may detect a distance between its current position and a surrounding object during the cruising stage. When the distance is less than a preset distance, the surrounding object may be considered to be an obstacle. Correspondingly, the cruising stage may also include an obstacle avoidance stage.

In the obstacle avoidance stage, the unmanned aerial vehicle may first perform a braking and hovering operation and calculate a retreat position. Then the unmanned aerial vehicle may retreat to the retreat position. When the distance between the position of the unmanned aerial vehicle and the retreat position is less than a preset distance, or the retreat time exceeds a preset time, the unmanned aerial vehicle may start ascending to avoid obstacles. The unmanned aerial vehicle may continuously detect the distance to the obstacle during the obstacle avoidance ascending. When the distance from the obstacle is larger than a preset distance or the obstacle avoidance ascending time exceeds a preset time, the unmanned aerial vehicle may continue to cruise to the home point with the height after the obstacle avoidance ascending.

At S102, in the cruising stage, flight parameters of the unmanned aerial vehicle may be measured and the unmanned aerial vehicle may enter a high wind course reversal stage when it is determined that the unmanned aerial vehicle is in a high wind retardant state.

In one embodiment, the flight parameters may include airspeed and ground speed of the unmanned aerial vehicle. The unmanned aerial vehicle may be equipped with a positioning device and an airspeed meter for measuring the ground speed and the airspeed of the unmanned aerial vehicle respectively. The ground speed may refer to the speed of the unmanned aerial vehicle relative to the ground, and the airspeed may refer to the speed of the unmanned aerial vehicle relative to the air. The positioning device may include a GPS receiver and/or an inertial measurement device. The airspeed meter may include a Pitot tube mounted outside a vehicle body of the unmanned aerial vehicle. When the unmanned aerial vehicle is flying in the air, incoming flow facing the Pitot tube may produce stagnant pressure at a total pressure hole of the Pitot tube, and a static pressure hole of the Pitot tube may be used to measure a static pressure. Correspondingly, the airspeed meter may calculate dynamic pressure according to the Bernoulli equation to obtain the airspeed of the unmanned aerial vehicle.

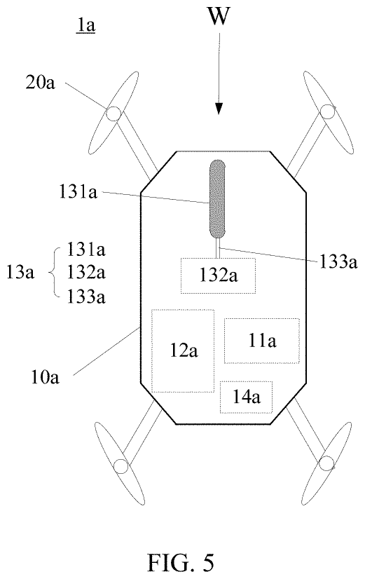

In one embodiment, the high wind retardant state may refer to a speed retardant state. For the course reversal action, when the wind direction W is opposite to the cruising direction as shown in FIG. 5, the relatively larger airspeed of the unmanned aerial vehicle may indicate two possible situations. One situation may be that the unmanned aerial vehicle is in an environment with no wind, with a very low wind speed, or with a low wind speed, and is flying at a high ground speed. Another situation may be the speed retardant state, that is, the wind speed is very high and the ground speed of the unmanned aerial vehicle is very small or even zero. In this case, although the airspeed measured by the airspeed meter is very large, the unmanned aerial vehicle may hardly fly to the home point because of the effect of wind, and it may be difficult to complete the course reversal action if the unmanned aerial vehicle continues to cruise.

Therefore, in the cruising stage, the airspeed meter and the positioning device may be used to measure the airspeed and the ground speed of the unmanned aerial vehicle respectively. A difference between the airspeed and the ground speed of the unmanned aerial vehicle may be calculated and it may be determined whether the difference between the airspeed and the ground speed of the unmanned aerial vehicle is larger than a first threshold value. When the difference between the airspeed and the ground speed of the unmanned aerial vehicle is smaller than the first threshold value, it may be determined that the wind speed is not high and the cruise of the unmanned aerial vehicle is not affected. When the difference between the airspeed and the ground speed of the unmanned aerial vehicle is larger than the first threshold value, it may be determined that the wind speed is high and the unmanned aerial vehicle can hardly fly to the home point because of the effect of wind. Correspondingly, the unmanned aerial vehicle may need to enter the high wind course reversal stage.

When the unmanned aerial vehicle is cruising, the vehicle body of the unmanned aerial vehicle may have a certain inclination with respect to the horizontal plane regardless of whether the nose or tail of the unmanned aerial vehicle is facing the home point. When the wind speed is very high, to offset the effect of the wind, the unmanned aerial vehicle may continuously increase the inclination angle and fly with a maximum flight inclination angle.

Correspondingly, in one embodiment, the airspeed of the unmanned aerial vehicle measured in the cruising stage may be the airspeed of the unmanned aerial vehicle when the unmanned aerial vehicle cruises at the maximum flight inclination angle. That is, when the unmanned aerial vehicle cruises at the maximum flight inclination angle, an axial direction of the Pitot tube may be parallel to the cruising heading direction, to improve measurement accuracy of the airspeed. Correspondingly, the determination result of the speed retardant state may be obtained more accurately.

Further, what enters the Pitot tube may be the air outside an area affected by airflow of the vehicle body of the unmanned aerial vehicle. The area affected by the airflow of the vehicle body of the unmanned aerial vehicle may be an area around the rotors, especially an area below the rotors. The airspeed meter may use the air outside the area affected by the airflow of the vehicle body of the unmanned aerial vehicle to measure the airspeed, to prevent the Pitot tube from being affected by the airflow of the vehicle body and further improve the accuracy of the airspeed measurement.

At S103, in the high wind course reversal stage, the flight parameters may be measured and the unmanned aerial vehicle may return to the cruising stage when it is determined that the unmanned aerial vehicle has exited the high wind retardant state according to the flight parameters.

Wind is formed by the large-scale movement of air. When the wind flows across the ground, friction between the air and objects on the ground may cause the wind speed to drop. As the altitude drops, the influence of the friction between the air and the ground may gradually increase, and the airflow speed may decrease. Therefore, for the unmanned aerial vehicle flying near the ground surface, the wind speed may decrease as the altitude drops.

Correspondingly, to overcome the speed retardant state, in the high wind course reversal stage, the unmanned aerial vehicle may enter a descending stage such that the unmanned aerial vehicle may maintain its cruising power and descend at a preset speed. When the unmanned aerial vehicle descends, the wind speed may decrease gradually. It may be determined in real time whether the unmanned aerial vehicle has exited the speed retardant state. When the unmanned aerial vehicle has exited the speed retardant state, the unmanned aerial vehicle may stop descending and return to the cruising stage to continue flying to the home point.

When the unmanned aerial vehicle descends, the airspeed and the ground speed of the unmanned aerial vehicle may be measured by the airspeed meter and the positioning device respectively. The difference between the airspeed and the ground speed of the unmanned aerial vehicle may be calculated and it may be determined whether the difference between the airspeed and the ground speed of the unmanned aerial vehicle is larger than the first threshold value. In response to the difference between the airspeed and the ground speed of the unmanned aerial vehicle being larger than the first threshold value, it may be determined that the unmanned aerial vehicle is still in the speed retardant state. In response to the difference between the airspeed and the ground speed of the unmanned aerial vehicle being smaller than the first threshold value, it may be determined that the unmanned aerial vehicle exits the speed retardant state. The unmanned aerial vehicle may return to the cruising stage, and cruise to the home point with the height after descending.

In one embodiment, the unmanned aerial vehicle may perform obstacle avoidance in the high wind course reversal stage. In the descending stage, when there are obstacles under the unmanned aerial vehicle, the unmanned aerial vehicle may stop descending and maintain its cruise power. When the obstacles are no longer under the unmanned aerial vehicle, the unmanned aerial vehicle may continue descending. The unmanned aerial vehicle may be prevented from being damaged by the obstacles and the safety of the cruise may be improved.

In the present disclosure, it may be detected whether the unmanned aerial vehicle is in the speed retardant state in the cruising stage and corresponding course reversal strategies may be performed accordingly. The effect of the high wind on the course reversal may be avoided, to guarantee that the unmanned aerial vehicle can return safely. Problems that the unmanned aerial vehicle runs out of power and cannot return because of slow or even stagnant speed in the high wind in the existing technologies may be alleviated, to improve the reliability and safety of course reversal of the unmanned aerial vehicle.

When the unmanned aerial vehicle in normal flight meets the high wind and enters the speed retardant state, it may be already difficult for the unmanned aerial vehicle to fly normally. When the unmanned aerial vehicle is in a flying state, the control method of the present disclosure may measure the flight parameters. When it is determined that the unmanned aerial vehicle is in the high wind retardant state based on the flight parameters, the course reversal command may be generated.

Therefore, the airspeed meter and the positioning device may be used to measure the airspeed and the ground speed of the unmanned aerial vehicle respectively. The difference between the airspeed and the ground speed of the unmanned aerial vehicle may be calculated and it may be determined whether the difference between the airspeed and the ground speed of the unmanned aerial vehicle is larger than the first threshold value. In response to the difference between the airspeed and the ground speed of the unmanned aerial vehicle being smaller than the first threshold value, it may be determined that the wind speed is not high and the flight of the unmanned aerial vehicle is not affected. In response to the difference between the airspeed and the ground speed of the unmanned aerial vehicle being larger than the first threshold value, it may be determined that the wind speed is high and the unmanned aerial vehicle can hardly fly to the home point because of the effect of wind. The course reversal command may be generated such that the unmanned aerial vehicle may execute the course reversal action.

In the present disclosure, it may be determined whether the unmanned aerial vehicle is in the speed retardant state in the normal flight stage. The course reversal command may be generated accordingly to avoid the effect of the high wind on the normal flight. The reliability and safety of the flight of the unmanned aerial vehicle may be further improved.

The present disclosure also provides another control method of an unmanned aerial vehicle. For simplicity, the features of the present control method same as the previous embodiments will not be repeated here and only the features of the present control method different from the previous embodiments will be described below.

In one embodiment, the control method may include controlling the unmanned aerial vehicle to enter the high wind course reversal stage when the unmanned aerial vehicle is in the high wind retardant state during the cruising stage. The high wind retardant state may refer to a heading deviation state and the flight parameters may include the actual heading of the unmanned aerial vehicle.

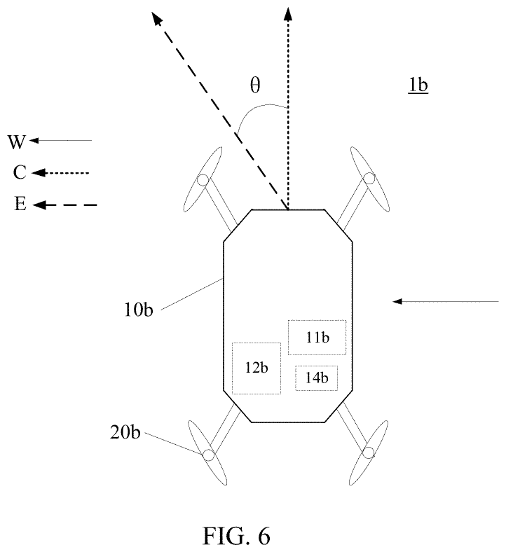

In the cruising stage, when the wind direction W is perpendicular to the cruising heading C of the unmanned aerial vehicle as illustrated in FIG. 6, the actual heading E of the unmanned aerial vehicle may deviate from the cruising heading C under the wind, and an angle θ may be formed between the actual heading E and the cruising heading C of the unmanned aerial vehicle. A magnitude of the angle θ represents a magnitude of the difference between the actual heading E and the cruising heading C. The angle θ may increase as the wind increases. When the angle θ is too large, the actual heading E may deviate largely from the cruising heading C and the unmanned aerial vehicle cannot fly to the home point successfully.

Therefore, in one embodiment, in the cruising stage, the positioning device may be used to measure the actual heading E of the unmanned aerial vehicle, and the difference between the actual heading E and the cruising heading C may be calculated. Then whether the difference between the actual heading E and the cruising heading C is larger than a second threshold value may be determined. When the difference between the actual heading E and the cruising heading C is smaller than the second threshold value, it may be determined that the wind is not high and the cruising of the unmanned aerial vehicle may not be affected. When the difference between the actual heading E and the cruising heading C is larger than the second threshold value, it may be determined that the wind is high and the unmanned aerial vehicle is flying along a direction deviating from the home point because of the effect of the wind. Correspondingly it may be determined that the unmanned aerial vehicle is in the heading deviation state and it may be needed to control the unmanned aerial vehicle to enter the high wind course reversal stage.

Similar to the previous embodiments, to overcome the heading deviation state, in the high wind course reversal stage, the unmanned aerial vehicle may enter the descending stage. In the descending stage, the wind speed may decrease gradually and it may be determined in real time whether the unmanned aerial vehicle has exited the heading deviation state. When the unmanned aerial vehicle has exited the heading deviation state, the unmanned aerial vehicle may stop descending and return to the cruising stage to continue flying to the home point.

In the descending stage, the positioning device may be used to measure the actual heading E of the unmanned aerial vehicle, and the difference between the actual heading E and the cruising heading C may be calculated. Then whether the difference between the actual heading E and the cruising heading C is larger than a second threshold value may be determined. When the difference between the actual heading E and the cruising heading C is still larger than the second threshold value, it may be determined that the unmanned aerial vehicle is still in the heading deviation state. When the difference between the actual heading E and the cruising heading C is smaller than the second threshold value, it may be determined that the unmanned aerial vehicle has exited the heading deviation state and the unmanned aerial vehicle may return to the cruising stage and cruise to the home point at the height after descending.

In the present disclosure, it may be detected whether the unmanned aerial vehicle is in the heading deviation state in the cruising stage and corresponding course reversal strategies may be performed accordingly. The effect of the high wind on the course reversal may be avoided, to guarantee that the unmanned aerial vehicle can return safely. Problems that the unmanned aerial vehicle runs out of power and cannot return because of slow or even stagnant speed in the high wind in the existing technologies may be alleviated, to improve the reliability and safety of course reversal of the unmanned aerial vehicle.

When the unmanned aerial vehicle is in a flying state, the control method of the present disclosure may measure the flight parameters. When it is determined that the unmanned aerial vehicle is in the high wind retardant state based on the flight parameters, the course reversal command may be generated.

Therefore, in the cruising stage, the positioning device may be used to measure the actual heading E of the unmanned aerial vehicle, and the difference between the actual heading E and the cruising heading C may be calculated. Then whether the difference between the actual heading E and the cruising heading C is larger than a second threshold value may be determined. When the difference between the actual heading E and the cruising heading C is smaller than the second threshold value, it may be determined that the wind is not high and the cruising of the unmanned aerial vehicle may not be affected. When the difference between the actual heading E and the cruising heading C is larger than the second threshold value, it may be determined that the wind speed is high and the unmanned aerial vehicle can hardly fly to the home point because of the effect of wind. The course reversal command may be generated such that the unmanned aerial vehicle may execute the course reversal action.

In the present disclosure, it may be determined whether the unmanned aerial vehicle is in the heading deviation state in the normal flight stage. The course reversal command may be generated accordingly to avoid the effect of the high wind on the normal flight. The reliability and safety of the flight of the unmanned aerial vehicle may be further improved.

The present disclosure also provides another control method of an unmanned aerial vehicle. For simplicity, the features of the present control method same as the previous embodiments will not be repeated here and only the features of the present control method different from the previous embodiments will be described below.

In one embodiment, the control method may include controlling the unmanned aerial vehicle to enter the high wind course reversal stage when the unmanned aerial vehicle is in the high wind retardant state during the cruising stage. The high wind retardant state may include a speed retardant state and a heading deviation state. The flight parameters may include the airspeed, the ground speed, and the actual heading of the unmanned aerial vehicle.

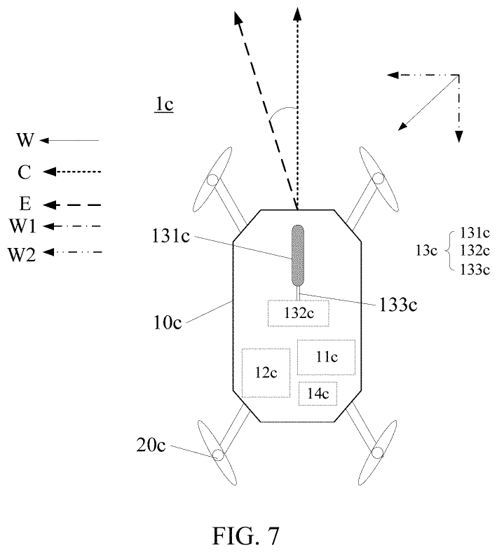

In the cruising stage, the wind direction W may be neither perpendicular nor parallel to the cruising heading C of the unmanned aerial vehicle as illustrated in FIG. 7. Correspondingly, the wind direction W may be decomposed to a component W1 parallel to the cruising heading and a component W2 perpendicular to the cruising heading. Along the W1 direction, a component of the wind may induce the unmanned aerial vehicle to be in the speed retardant state. Along the W2 direction, a component of the wind may induce the unmanned aerial vehicle to be in the heading deviation state.

Therefore, in one embodiment, in the cruising stage, the airspeed meter may be used to measure the airspeed of the unmanned aerial vehicle, and the positioning device may be used to measure the ground speed and the actual heading E of the unmanned aerial vehicle. The difference between the airspeed and the ground speed of the unmanned aerial vehicle, and the difference between the actual heading E and the cruising heading C may be calculated.

Then whether the difference between the actual heading E and the cruising heading C is larger than a second threshold value, and whether the difference between the airspeed and the ground speed is larger than the first threshold value, may be determined. When either of the above two conditions is true, it may be determined that it is hard for the unmanned aerial vehicle to fly to the home point or the unmanned aerial vehicle is flying along a direction deviating from the home point because of the effect of the wind. When both of the above two conditions are true, it may be determined that it is hard for the unmanned aerial vehicle to fly to the home point and the unmanned aerial vehicle is flying along a direction deviating from the home point because of the effect of the wind. Correspondingly it may be determined that the unmanned aerial vehicle is in the speed retardant state and/or the heading deviation state and it may be needed to control the unmanned aerial vehicle to enter the high wind course reversal stage.

Similar to the previous embodiments, to overcome the high wind retardant state, in the high wind course reversal stage, the unmanned aerial vehicle may enter the descending stage. In the descending stage, the wind speed may decrease gradually and it may be determined in real time whether the unmanned aerial vehicle has exited the speed retardant state and the heading deviation state. When the unmanned aerial vehicle has exited the speed retardant state and the heading deviation state, the unmanned aerial vehicle may stop descending and return to the cruising stage to continue flying to the home point.

In the descending stage, the airspeed meter may be used to measure the airspeed of the unmanned aerial vehicle, and the positioning device may be used to measure the ground speed and the actual heading E of the unmanned aerial vehicle. The difference between the airspeed and the ground speed of the unmanned aerial vehicle, and the difference between the actual heading E and the cruising heading C may be calculated.

Then whether the difference between the actual heading E and the cruising heading C is larger than a second threshold value, and whether the difference between the airspeed and the ground speed is larger than the first threshold value, may be determined. When both of the above two conditions are not true, it may be determined that the unmanned aerial vehicle has exited the high wind retardant state and the unmanned aerial vehicle may return to the cruising stage and cruise to the home point at the height after descending.

In the present disclosure, it may be detected whether the unmanned aerial vehicle is in the speed retardant state and the heading deviation state in the cruising stage and corresponding course reversal strategies may be performed accordingly. The effect of the high wind on the course reversal may be avoided, to guarantee that the unmanned aerial vehicle can return safely. Problems that the unmanned aerial vehicle runs out of power and cannot return because of slow or even stagnant speed in the high wind in the existing technologies may be alleviated, to improve the reliability and safety of course reversal of the unmanned aerial vehicle.

When the unmanned aerial vehicle is in a flying state, the control method of the present disclosure may measure the flight parameters. When it is determined that the unmanned aerial vehicle is in the high wind retardant state based on the flight parameters, the course reversal command may be generated.

Therefore, in one embodiment, in the cruising stage, the airspeed meter may be used to measure the airspeed of the unmanned aerial vehicle, and the positioning device may be used to measure the ground speed and the actual heading E of the unmanned aerial vehicle. The difference between the airspeed and the ground speed of the unmanned aerial vehicle, and the difference between the actual heading E and the cruising heading C may be calculated.

Then whether the difference between the actual heading E and the cruising heading C is larger than a second threshold value, and whether the difference between the airspeed and the ground speed is larger than the first threshold value, may be determined. When either of the above two conditions is true, the course reversal command may be generated such that the unmanned aerial vehicle may execute the above course reversal action.

In the present disclosure, it may be determined whether the unmanned aerial vehicle is in the high wind retardant state in the normal flight stage. The course reversal command may be generated accordingly to avoid the effect of the high wind on the normal flight. The reliability and safety of the flight of the unmanned aerial vehicle may be further improved.

The present disclosure also provides an unmanned aerial vehicle. In one embodiment, as illustrated in FIG. 5, the unmanned aerial vehicle 1a includes a vehicle body 10a and a propulsion device 20a. The propulsion device 20a includes four arms extending from the vehicle body 10a and a rotor installed at each arm for generating propulsion.

The vehicle body 10a is equipped with a controller 11a, an airspeed measurement device, and a ground speed measurement device. Flight parameters include an airspeed and a ground speed of the unmanned aerial vehicle.

The ground speed measurement device may be a positioning device 12a such as a GPS receiver or an inertial measurement device. The ground speed measurement device may be disposed inside the vehicle body 10a and electrically connected to the controller 11a, for measuring the ground speed of the unmanned aerial vehicle 1a during flying.

The airspeed measurement device may be an airspeed meter 13a electrically connected to the controller 11a, for measuring the airspeed of the unmanned aerial vehicle 1a during flying.

The controller 11a may be disposed inside the vehicle body 10a, for receiving measurement values of the airspeed measurement device and the ground speed measurement device, and further for controlling actions of the propulsion device 20a to control the flight of the unmanned aerial vehicle 1a.

In one embodiment, the controller 11a may be configured to generate a course reversal command to control the unmanned aerial vehicle 1a to execute the course reversal action. The course reversal action may at least include a cruising stage.

In the cruising stage, the airspeed meter 13a and the positioning device 12a may be used to measure the airspeed and the ground speed of the unmanned aerial vehicle 1a respectively. When the controller 11a determines that the unmanned aerial vehicle 1a is in a speed retardant state, the controller 11a may control the unmanned aerial vehicle 1a to enter a high wind course reversal stage. Specifically, a difference between the airspeed and the ground speed of the unmanned aerial vehicle 1a may be calculated and it may be determined whether the difference between the airspeed and the ground speed of the unmanned aerial vehicle is larger than a first threshold value. In response to the difference between the airspeed and the ground speed of the unmanned aerial vehicle being smaller than the first threshold value, it may be determined that the wind speed is not high and the cruise of the unmanned aerial vehicle 1a is not affected. In response to the difference between the airspeed and the ground speed of the unmanned aerial vehicle being larger than the first threshold value, it may be determined that the wind speed is high and the unmanned aerial vehicle 1a can hardly fly to the home point because of the effect of wind, such that the unmanned aerial vehicle may need to enter the high wind course reversal stage.

The airspeed meter 13a includes a Pitot tube 131a disposed outside of the vehicle body 10a of the unmanned aerial vehicle and a pressure gauge 132a disposed inside the vehicle body 10a.

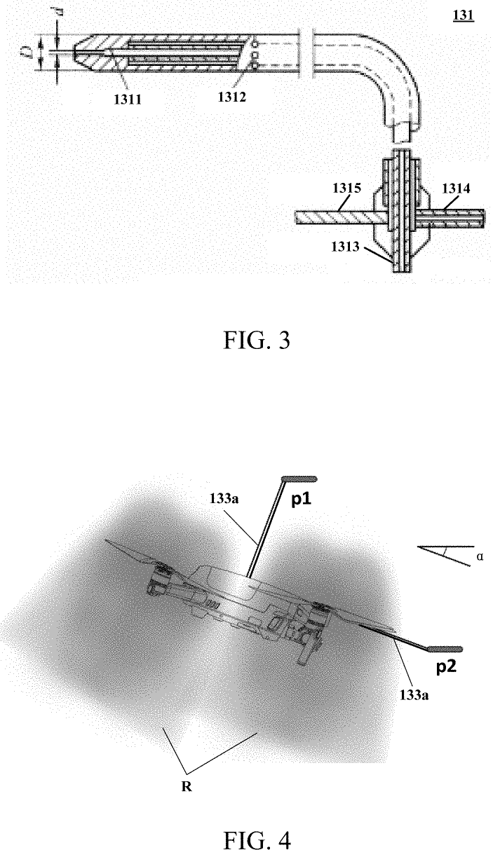

The Pitot tube 131a, also known as an airspeed tube, is a device for measuring fluid point speed. As shown in FIG. 3, an L-shaped Pitot tube may be used. The L-shaped Pitot tube may be a metal tube bent at a right angle and may include two layers of sleeves, that is, a total pressure tube and a static pressure tube which are not in communication with each other. A section of the L-shaped Pitot tube may be a probe, and D denotes the diameter of the probe. A total pressure hole 1311 in communication with the total pressure tube is opened at the top of the probe, and d denotes the diameter of the total pressure hole 1311. A static pressure hole 1312 in communication with the static pressure tube is opened on the side of the probe. Other sections of the L-shaped Pitot tube may be a support rod. A total pressure outlet tube 1313, a static pressure outlet tube 1314, and an alignment handle 1315 are disposed at the bottom end of the support rod.

The pressure gauge 132a may include a piezoelectric sensor and a processing circuit. The piezoelectric sensor may be configured to convert a pressure signal to an electric signal. The processing circuit may include an amplifier, a filter, and an analog to digital (A/D) converter, for processing the electric signal output by the piezoelectric sensor to obtain the measurement value of the pressure.

As illustrated in FIG. 4, the Pitot tube 131a may be mounted at a back of the vehicle body 10a (Pitot tube position p1), a front or a rear of the vehicle body 10a (Pitot tube position p2), through a support tube 133a. The support tube 133a may include two layers of sleeves including an inner tube and an outer tube that are not in communication with each other. An end of the inner tube may be in communication with the total pressure outlet tube 1313, and an end of the outer tube may be in communication with the static pressure outlet tube 1314. Another end of the inner tube and another end of the outer tube may both be connected to the piezoelectric sensor of the pressure gauge 132a.

In the cruising stage, the air may enter the Pitot tube 131a through the total pressure hole 1311, and then enter the pressure gauge 132a through the total pressure tube, the total pressure outlet tube 1313, and the inner tube of the support tube 133a. The piezoelectric sensor of the pressure gauge 132a may convert the air pressure to the electric signal. The measurement value of the total pressure may be obtained after the electric signal is amplified by the amplifier, filtered by the filter and converted by the A/D converter. The air may the Pitot tube 131a through the static pressure hole 1312, and may enter the pressure gauge 132a through the static pressure tube, the static pressure outlet tube 1314, and the outer tube of the support tube 133a. The piezoelectric sensor of the pressure gauge 132a may convert the air pressure to the electric signal. The measurement value of the static pressure may be obtained after the electric signal is amplified by the amplifier, filtered by the filter and converted by the A/D converter. The controller 11a may receive the measurement values of the total pressure and the static pressure acquired by the airspeed meter 13a, and calculate the dynamic pressure and the airspeed of the unmanned aerial vehicle according to the Bernoulli equation.

In the unmanned aerial vehicle 1a of the present disclosure, the Pitot tube 131a may be mounted outside the vehicle body 10a through the support tube 133a. The Pitot tube 131a may be spaced a certain distance from the vehicle body 10a, and located outside an area R affected by the airflow of the vehicle body, such as an area around the rotor, especially under the rotor. The airflow of the vehicle body 10a may be prevented from affecting the Pitot tube 131a, and the accuracy of airspeed measurement can be further improved.

As illustrated in FIG. 4, an angle of an axial direction of the Pitot tube 131a with respect to the vehicle body 10a may equal a maximum flight inclination angle α of the unmanned aerial vehicle la. That is, when the unmanned aerial vehicle 1a cruises with the maximum flight inclination angle α, the axial direction of the Pitot tube 131a may be parallel to the cruising heading, and the Pitot tube 131a may measure the airspeed of the unmanned aerial vehicle 1a when the unmanned aerial vehicle 1a cruises with the maximum flight inclination angle α. The accuracy of the airspeed measurement may be improved, and the accuracy of the determination of whether the unmanned aerial vehicle is in the speed retardant state may be improved.

The above embodiments are used as examples to illustrate the present disclosure and do not limit the scopes of the present disclosure. For example, in some other embodiments, two Pitot tubes 131a may be mounted at the back of the vehicle body 10a toward the nose direction and the tail direction respectively. For example, in some other embodiments, Pitot tubes 131a may be mounted at both the front and the back of the vehicle body 10a. Correspondingly, the airspeed may be measured regardless of whether the nose of the unmanned aerial vehicle 1a faces the home point or the tail faces the home point. Pitot tubes 131a may be directly mounted at surfaces of the back, front or rear of the vehicle body 10a. The whole volume and size of the unmanned aerial vehicle 1a may be reduced, to avoid affecting the appearance of the unmanned aerial vehicle 1a.

In the high wind course reversal stage, the airspeed meter 13a may measure the airspeed of the unmanned aerial vehicle 1a during flying, and the positioning device 12a may measure the ground speed of the unmanned aerial vehicle 1a during flying. The controller 11a may determine whether the difference between the airspeed and the ground speed is larger than the first threshold value. When the difference between the airspeed and the ground speed is not larger than the first threshold value, the unmanned aerial vehicle 1a may exit the speed retardant state and the controller 11a may control the unmanned aerial vehicle 1a to return to the cruising stage.

To overcome the speed retardant state, in the high wind course reversal stage, the controller 11a may generate a command to control the unmanned aerial vehicle 1a to enter the descending stage. In the descending stage, the unmanned aerial vehicle 1a may maintain cruising power and descend with a preset speed. In the descending stage, the wind speed may decrease gradually. The controller 11a may determine in real time whether the unmanned aerial vehicle 1a has exited the speed retardant state. When the unmanned aerial vehicle 1a has exited the speed retardant state, the controller 1a may control the unmanned aerial vehicle 1a to stop descending and return to the cruising stage to continue flying to the home point.

In the descending stage, the airspeed meter 13a may measure the airspeed of the unmanned aerial vehicle 1a, and the positioning device 12a may measure the ground speed of the unmanned aerial vehicle 1a. The controller 11a may determine whether the difference between the airspeed and the ground speed is larger than the first threshold value. When the difference between the airspeed and the ground speed is still larger than the first threshold value, it may be determined that the unmanned aerial vehicle 1a is still in the speed retardant state. When the difference between the airspeed and the ground speed is smaller than the first threshold value, it may be determined that the unmanned aerial vehicle 1a has exited the speed retardant state. The unmanned aerial vehicle 1a may be controlled to return to the cruising stage and cruise to the home point with the height after descending.

The vehicle body 10a of the unmanned aerial vehicle 1a may be further equipped with an obstacle detector 14a for detecting obstacles below the vehicle body 10a. In the descending stage, when the obstacle detector 14a detects that there are obstacles under the unmanned aerial vehicle 1a, the controller 11a may control the unmanned aerial vehicle to stop descending and maintain its cruise power. When the obstacle detector 14a detects that the obstacles are no longer under the unmanned aerial vehicle, the controller 11a may control the unmanned aerial vehicle to continue descending. The unmanned aerial vehicle 1a may be prevented from being damaged by the obstacles and the safety of the cruise may be improved.

When the unmanned aerial vehicle 1a flies normally, the airspeed meter 13a may measure the airspeed of the unmanned aerial vehicle 1a, and the positioning device 12a may measure the ground speed of the unmanned aerial vehicle 1a. The controller 11a may calculate the difference between the airspeed and the ground speed of the unmanned aerial vehicle 1a and determine whether the difference between the airspeed and the ground speed is larger than the first threshold value. In response to the difference between the airspeed and the ground speed of the unmanned aerial vehicle being smaller than the first threshold value, it may be determined that the wind speed is not high and the cruise of the unmanned aerial vehicle 1a is not affected. In response to the difference between the airspeed and the ground speed of the unmanned aerial vehicle being larger than the first threshold value, it may be determined that the wind speed is high and the unmanned aerial vehicle 1a can hardly fly to the home point and is in the speed retardant state because of the effect of wind. The controller 11a may generate the course reversal command to control the unmanned aerial vehicle 1a to execute the above course reversal action.

In the present disclosure, the airspeed meter and the positioning device may be used to detect whether the unmanned aerial vehicle is in the speed retardant state in the cruising stage and corresponding course reversal strategies may be performed accordingly. The effect of the high wind on the course reversal may be avoided, to guarantee that the unmanned aerial vehicle can return safely. Problems that the unmanned aerial vehicle runs out of power and cannot return because of slow or even stagnant speed in the high wind in the existing technologies may be alleviated, to improve the reliability and safety of course reversal of the unmanned aerial vehicle. When the unmanned aerial vehicle is in normal flight, the airspeed meter and the positioning device may be used to detect whether the unmanned aerial vehicle is in the high wind retardant state. When the unmanned aerial vehicle is in the high wind retardant state, the course reversal command may be generated to avoid the effect of the high wind on the normal flight. The reliability and safety of the flight of the unmanned aerial vehicle may be further improved.

Another embodiment of the present disclosure also provides an unmanned aerial vehicle 1b as illustrated in FIG. 6. For simplicity, the features of the present embodiment same as the previous embodiments will not be repeated here and only the features different from the previous embodiments will be described below.

As illustrated in FIG. 6, the vehicle body 10b is provided with a controller 11b and a heading measurement device. The flight parameters may include the actual heading E of the unmanned aerial vehicle 1b.

The heading measurement device may be a positioning device 12b such as a GPS receiver or an inertial measurement device. The heading measurement device may be disposed inside the vehicle body 10b and electrically connected to the controller 11b, for measuring the actual heading E of the unmanned aerial vehicle 1b when the unmanned aerial vehicle 1b is flying.

The controller 11b may be disposed inside the vehicle body 10b, for receiving measurement values of the heading measurement device, and further for controlling actions of the propulsion device 20b to control the flight of the unmanned aerial vehicle 1b.

In one embodiment, the controller 11b may be configured to generate a course reversal command to control the unmanned aerial vehicle 1b to execute the course reversal action. The course reversal action may at least include a cruising stage.

In the cruising stage, the positioning device 12b may measure the actual heading E of the unmanned aerial vehicle 1b. The controller 1 1b may calculate a difference between the actual heading E and the cruising heading C, and then determine whether the difference between the actual heading E and the cruising heading C is larger than a second threshold value. When the difference between the actual heading E and the cruising heading C is smaller than the second threshold value, it may be determined that the wind is not high and the cruising of the unmanned aerial vehicle 1b may not be affected. When the difference between the actual heading E and the cruising heading C is larger than the second threshold value, it may be determined that the wind is high and the unmanned aerial vehicle 1b is flying along a direction deviating from the home point because of the effect of the wind. Correspondingly the controller 11b may determine that the unmanned aerial vehicle is in the heading deviation state and control the unmanned aerial vehicle to enter the high wind course reversal stage.

To overcome the heading deviation state, in the high wind course reversal stage, the controller 11b may control the unmanned aerial vehicle to enter the descending stage. In the descending stage, the wind speed may decrease gradually and the controller 11b may determine in real time whether the unmanned aerial vehicle 1b has exited the heading deviation state. When the unmanned aerial vehicle exits the heading deviation state, the controller 11b may control the unmanned aerial vehicle to stop descending and return to the cruising stage to continue flying to the home point.

In the descending stage, the positioning device 12b may be used to measure the actual heading E of the unmanned aerial vehicle 1b. The controller 11b may calculate the difference between the actual heading E and the cruising heading C may be calculated, and then determine whether the difference between the actual heading E and the cruising heading C is larger than a second threshold value may be determined. When the difference between the actual heading E and the cruising heading C is still larger than the second threshold value, it may be determined that the unmanned aerial vehicle 1b is still in the heading deviation state. When the difference between the actual heading E and the cruising heading C is smaller than the second threshold value, it may be determined that the unmanned aerial vehicle 1b exits the heading deviation state and the controller l 1b may control the unmanned aerial vehicle 1b to return to the cruising stage and cruise to the home point at the height after descending.

Similar to the previous embodiment, the vehicle body 10b of the unmanned aerial vehicle 1b is further provided with an obstacle detector 14b for detecting obstacles below the vehicle body 10b.

When the unmanned aerial vehicle 1b flies normally, the positioning device 12b may be used to measure the actual heading E of the unmanned aerial vehicle. The controller 11b may calculate the difference between the actual heading E and the cruising heading C, and determine whether the difference between the actual heading E and the cruising heading C is larger than a second threshold value. When the difference between the actual heading E and the cruising heading C is smaller than the second threshold value, it may be determined that the wind is not high and the normal flight of the unmanned aerial vehicle 1b may not be affected. When the difference between the actual heading E and the cruising heading C is larger than the second threshold value, it may be determined that the wind speed is high and the unmanned aerial vehicle 1b deviates largely from the preset flight heading. Correspondingly the controller 11b may determine that the unmanned aerial vehicle 1b is in the heading deviation state and generate the course reversal command to control the unmanned aerial vehicle 1b to execute the above course reversal action.

In the present disclosure, the positioning device may be used to determine whether the unmanned aerial vehicle is in the heading deviation state in the cruising stage and corresponding course reversal strategies may be performed accordingly. The effect of the high wind on the course reversal may be avoided, to guarantee that the unmanned aerial vehicle can return safely. Problems that the unmanned aerial vehicle runs out of power and cannot return because of slow or even stagnant speed in the high wind in the existing technologies may be alleviated, to improve the reliability and safety of course reversal of the unmanned aerial vehicle. In the normal flight, a positioning device may be used to determine whether the unmanned aerial vehicle is in the heading deviation state in the normal flight stage. The course reversal command may be generated accordingly to avoid the effect of the high wind on the normal flight. The reliability and safety of the flight of the unmanned aerial vehicle may be further improved.

Another embodiment of the present disclosure also provides an unmanned aerial vehicle 1c as illustrated in FIG. 7. For simplicity, the features of the present embodiment same as the previous embodiments will not be repeated here and only the features different from the previous embodiments will be described below.

As illustrated in FIG. 7, the vehicle body 10c is provided with a controller 11c, an airspeed measurement device, a ground speed measurement device, and a heading measurement device. The flight parameters may include the airspeed, the ground speed, and the actual heading E of the unmanned aerial vehicle 1c.

The ground speed measurement device may be a positioning device 12c such as a GPS receiver or an inertial measurement device. The ground speed measurement device may be disposed inside the vehicle body 10c and electrically connected to the controller 11c, for measuring the ground speed and the actual heading E of the unmanned aerial vehicle 1c during flying.

The airspeed measurement device may be an airspeed meter 13c electrically connected to the controller 11c, for measuring the airspeed of the unmanned aerial vehicle 1c during flying. The airspeed meter 13c includes a Pitot tube 131c mounted outside the vehicle body 10c through a support tube 133c, and a pressure gauge mounted inside the vehicle body 10c.

The controller 11c may be disposed inside the vehicle body 10c, for receiving measurement values of the airspeed measurement device, the ground speed measurement device, and the heading measurement device, and further for controlling actions of the propulsion device 20c to control the flight of the unmanned aerial vehicle 1c.

In one embodiment, the controller 11c may be configured to generate a course reversal command to control the unmanned aerial vehicle 1c to execute the course reversal action. The course reversal action may at least include a cruising stage.

In the cruising stage, the airspeed meter 13c may measure the airspeed of the unmanned aerial vehicle 1c, and the positioning device 12c may measure the ground speed and the actual heading E of the unmanned aerial vehicle 1c. The controller 11c may calculate a difference between the airspeed and the ground speed of the unmanned aerial vehicle 1c, and a difference between the actual heading E and the cruising heading C. The controller 11c then may determine whether the difference between the airspeed and the ground speed of the unmanned aerial vehicle 1c is larger than a first threshold value and whether the difference between the actual heading E and the cruising heading C is larger than a second threshold value. When either of the above two conditions is true, it may be determined that the unmanned aerial vehicle 1c can hardly fly to the home point or is flying along a direction deviating from the home point because of the effect of the wind. When both of the above two conditions are true, it may be determined that the unmanned aerial vehicle 1c can hardly fly to the home point and is flying along a direction deviating from the home point because of the effect of the wind. Correspondingly the controller 11b may determine that the unmanned aerial vehicle 1c is in the speed retardant state and/or the heading deviation state, and may control the unmanned aerial vehicle to enter the high wind course reversal stage.

To overcome the heading deviation state, in the high wind course reversal stage, the controller 11b may control the unmanned aerial vehicle to enter the descending stage. In the descending stage, the wind speed may decrease gradually and the controller 11b may determine in real time whether the unmanned aerial vehicle 1b has exited the speed retardant state and the heading deviation state. When the unmanned aerial vehicle exits the speed retardant state and the heading deviation state, the controller 11b may control the unmanned aerial vehicle to stop descending and return to the cruising stage to continue flying to the home point.

In the descending stage, the airspeed meter 13c may be used to measure the airspeed of the unmanned aerial vehicle 1c, and the positioning device 12c may be used to measure the ground speed and the actual heading E of the unmanned aerial vehicle 1c. The controller 11c may calculate a difference between the airspeed and the ground speed of the unmanned aerial vehicle 1c, and a difference between the actual heading E and the cruising heading C. The controller 11c then may determine whether the difference between the airspeed and the ground speed of the unmanned aerial vehicle 1c is larger than a first threshold value and whether the difference between the actual heading E and the cruising heading C is larger than a second threshold value. When neither of the above two conditions is true, it may be determined that the unmanned aerial vehicle 1c exits the high wind retardant state and the controller 11c may control the unmanned aerial vehicle 1c to return to the cruising stage and cruise to the home point at the height after descending.

Similar to the previous embodiments, the vehicle body 10c of the unmanned aerial vehicle 1c is further provided with an obstacle detector 14c for detecting obstacles below the vehicle body 10c.

When the unmanned aerial vehicle 1c flies normally, the airspeed meter 13c may be used to measure the airspeed of the unmanned aerial vehicle 1c, and the positioning device 12c may be used to measure the ground speed and the actual heading E of the unmanned aerial vehicle 1c. The controller 11c may calculate a difference between the airspeed and the ground speed of the unmanned aerial vehicle 1c, and a difference between the actual heading E and the cruising heading C. The controller 11c then may determine whether the difference between the airspeed and the ground speed of the unmanned aerial vehicle 1c is larger than a first threshold value and whether the difference between the actual heading E and the cruising heading C is larger than a second threshold value. When either of the above two conditions is true, the controller 11c may be configured to generate the course reversal command to control the unmanned aerial vehicle 1c to execute the above course reversal action.

In the present disclosure, whether the unmanned aerial vehicle is in the high wind retardant state may be determined in the cruising stage and the normal flight stage, and corresponding course reversal strategies may be performed. The effect of the high wind on the course reversal and the normal flight may be avoided, to guarantee that the unmanned aerial vehicle can return safely and fly normally. The reliability and safety of the flight of the unmanned aerial vehicle may be further improved.

In this disclosure, terms such as “first” and “second” are only used to distinguish one entity or operation from another entity or operation, and do not necessarily require or imply existence of any such relationship or sequence among these entities or operations. The terms “include,” “comprise” or any other variants thereof are intended to cover non-exclusive inclusion, so that a process, method, article, or device including a series of elements not only includes those elements, but also includes other elements not explicitly listed, or also includes elements inherent to such process, method, article, or device. If there are no more restrictions, the element associated with “including a . . .” does not exclude the existence of other identical elements in the process, method, article, or device that includes the element.

Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. A method for controlling an unmanned aerial vehicle comprising:
generating a course reversal command to control the unmanned aerial vehicle to execute a course reversal action, the course reversal action includes at least a cruising stage;
in the cruising stage, measuring one or more flight parameters of the unmanned aerial vehicle, and controlling the unmanned aerial vehicle to enter a high wind course reversal stage in response to determining that the unmanned aerial vehicle is in a high wind retardant state according to the one or more flight parameters; and
in the high wind course reversal stage, measuring the one or more flight parameters, and controlling the unmanned aerial vehicle to return to the cruising stage in response to determining that the unmanned aerial vehicle is not in the high wind retardant state according to the one or more flight parameters.

2. The method according to claim 1, wherein the high wind retardant state includes at least one of a speed retardant state or a heading deviation state.

3. The method according to claim 2, wherein:
the high wind retardant state is the speed retardant state;
the one or more flight parameters include an airspeed and a ground speed of the unmanned aerial vehicle;
in the cruising stage, determining that the unmanned aerial vehicle is in the high wind retardant state includes determining that the unmanned aerial vehicle is in the speed retardant state in response to determining that a difference between the airspeed and the ground speed is larger than a threshold; and
in the high wind course reversal stage, determining that the unmanned aerial vehicle is not in the high wind retardant state includes determining that the unmanned aerial vehicle has exited the speed retardant state in response to determining that the difference between the airspeed and the ground speed is not larger than the threshold.

4. The method according to claim 3, wherein the airspeed includes an airspeed of the unmanned aerial vehicle when the unmanned aerial vehicle is cruising with a maximum flight inclination angle.

5. The method according to claim 3, further comprising:
measuring the airspeed using air outside an area affected by airflow of the unmanned aerial vehicle.

6. The method according to claim 2, wherein:
the high wind retardant state is the heading deviation state;
the one or more flight parameters include an actual heading of the unmanned aerial vehicle;
in the cruising stage, determining that the unmanned aerial vehicle is in the high wind retardant state includes determining that the unmanned aerial vehicle is in the heading deviation state in response to determining that a difference between the actual heading and a cruising heading of the unmanned aerial vehicle is larger than a threshold; and
in the high wind course reversal stage, determining that the unmanned aerial vehicle is not in the high wind retardant state includes determining that the unmanned aerial vehicle has exited the heading deviation state in response to determining that the difference between the actual heading and the cruising heading is not larger than the threshold.

7. The method according to claim 2, wherein:
the high wind retardant state includes the speed retardant state and the heading deviation state;
the one or more flight parameters include an airspeed, a ground speed, and an actual heading of the unmanned aerial vehicle;
in the cruising stage, determining that the unmanned aerial vehicle is in the high wind retardant state includes determining that the unmanned aerial vehicle is in the high wind retardant state in response to determining that a difference between the airspeed and the ground speed is larger than a first threshold and/or a difference between the actual heading and a cruising heading of the unmanned aerial vehicle is larger than a second threshold; and
in the high wind course reversal stage, determining that the unmanned aerial vehicle is not in the high wind retardant state includes determining that the unmanned aerial vehicle has exited the high wind retardant state in response to determining that the difference between the airspeed and the ground speed is not larger than the first threshold and the difference between the actual heading and the cruising heading is not larger than the second threshold.

8. The method according to claim 1, further comprising:
in the high wind course reversal stage, controlling the unmanned aerial vehicle to enter a descending stage;
wherein controlling the unmanned aerial vehicle to return to the crusing stage includes, in the descending stage, controlling the unmanned aerial vehicle to stop descending and return to the cruising stage in response to determining that the unmanned aerial vehicle has exited the high wind retardant state.

9. The method according to claim 8, further comprising, in the descending stage:
controlling the unmanned aerial vehicle to stop descending in response to detecting an obstacle below the unmanned aerial vehicle; and
controlling the unmanned aerial vehicle to continue descending in response to determining that the obstacle is no longer located below the unmanned aerial vehicle.

10. The method according to claim 1, wherein generating the course reversal command includes:
measuring the one or more flight parameters when the unmanned aerial vehicle is in a flight state; and
generating the course reversal command in response to determining that the unmanned aerial vehicle is in the high wind retardant state according to the one or more flight parameters.

11. An unmanned aerial vehicle comprising:
a vehicle body;
at least one measurement device arranged at the vehicle body and configured to measure one or more flight parameters of the unmanned aerial vehicle; and
a controller arranged at the vehicle body and configured to:
generate a course reversal command to control the unmanned aerial vehicle to execute a course reversal action, the course reversal action includes at least a cruising stage;
in the cruising stage, control the unmanned aerial vehicle to enter a high wind course reversal stage in response to determining that the unmanned aerial vehicle is in a high wind retardant state according to the one or more flight parameters; and
in the high wind course reversal stage, control the unmanned aerial vehicle to return to the cruising stage in response to determining that the unmanned aerial vehicle is not in the high wind retardant state according to the one or more flight parameters.

12. The unmanned aerial vehicle according to claim 11, wherein the high wind retardant state includes at least one of a speed retardant state or a heading deviation state.

13. The unmanned aerial vehicle according to claim 12, wherein:
the at least one measurement device includes:
an airspeed meter configured to measure an airspeed of the unmanned aerial vehicle; and
a positioning device configured to measure a ground speed of the unmanned aerial vehicle;
the high wind retardant state is the speed retardant state; and
the controller is further configured to:
in the cruising stage, determine that the unmanned aerial vehicle is in the speed retardant state in response to determining that a difference between the airspeed and the ground speed is larger than a threshold; and
in the high wind course reversal stage, determine that the unmanned aerial vehicle has exited the speed retardant state in response to determining that the difference between the airspeed and the ground speed is not larger than the threshold.

14. The unmanned aerial vehicle according to claim 13, wherein the airspeed meter includes:
a Pitot tube mounted outside the vehicle body configured to form a total air pressure and a static air pressure; and
a pressure gauge mounted inside the vehicle body and connected to the Pitot tube, the pressure gauge being configured to detect the total air pressure and the static air pressure and determine the airspeed according to the total air pressure and the static air pressure.

15. The unmanned aerial vehicle according to claim 14, wherein an axial direction of the Pitot tube is parallel to a cruising heading of the unmanned aerial vehicle when the unmanned aerial vehicle cruises at a maximum flight inclination angle.

16. The unmanned aerial vehicle according to claim 14, wherein the Pitot tube is arranged at a certain distance away from the vehicle body and located outside an area affected by airflow of the unmanned aerial vehicle.

17. The unmanned aerial vehicle according to claim 14, wherein the Pitot tube is mounted at at least one of a back, a front, or a rear of the vehicle body.

18. The unmanned aerial vehicle according to claim 13, wherein the positioning device includes at least one of a GPS receiver or an inertial measurement device.

19. The unmanned aerial vehicle according to claim 12, wherein:
the at least one measurement device includes a positioning device configured to measure an actual heading of the unmanned aerial vehicle;
the high wind retardant state is the heading deviation state; and
the controller is further configured to:
in the cruising stage, determine that the unmanned aerial vehicle is in the heading deviation state in response to determining that a difference between the actual heading and a cruising heading of the unmanned aerial vehicle is larger than a threshold; and
in the high wind course reversal stage, determine that the unmanned aerial vehicle has exited the heading deviation state in response to determining that the difference between the actual heading and the cruising heading is not larger than the threshold.

20. The unmanned aerial vehicle according to claim 12, wherein:
the at least one measurement device includes:
an airspeed meter configured to measure an airspeed of the unmanned aerial vehicle; and
a positioning device configured to measure a ground speed and an actual heading of the unmanned aerial vehicle;
the high wind retardant state includes the speed retardant state and the heading deviation state; and
the controller is further configured to:
in the cruising stage, determine that the unmanned aerial vehicle is in the high wind retardant state in response to determining that a difference between the airspeed and the ground speed is larger than a first threshold and/or a difference between the actual heading and a cruising heading of the unmanned aerial vehicle is larger than a second threshold; and
in the high wind course reversal stage, determine that the unmanned aerial vehicle has exited the high wind retardant state in response to determining that the difference between the airspeed and the ground speed is not larger than the first threshold and the difference between the actual heading and the cruising heading is not larger than the second threshold.

21. The unmanned aerial vehicle according to claim 11, wherein the controller is further configured to:
in the high wind course reversal stage, control the unmanned aerial vehicle to enter a descending stage; and
in the descending stage, control the unmanned aerial vehicle to stop descending and return to the cruising stage in response to determining that the unmanned aerial vehicle has exited the high wind retardant state.

22. The unmanned aerial vehicle according to claim 21, further comprising:
an obstacle detector arranged at the vehicle body;
wherein the controller is further configured to, in the descending stage:
control the unmanned aerial vehicle to stop descending in response to the obstacle detector detecting an obstacle below the unmanned aerial vehicle; and
control the unmanned aerial vehicle to continue descending in response to the obstacle detector no longer detecting the obstacle.

23. The unmanned aerial vehicle according to claim 11, wherein the controller is further configured to, in a flight state, generate the course reversal command in response to determining that the unmanned aerial vehicle is in the high wind retardant state according to the one or more flight parameters.
